(19) United States
(12) Patent Application Publication
(10) Pub. No.: US 2025/0165835 A1
(43) Pub. Date: May 22, 2025

(54) TRAINING A COMBINATION OF MULTIPLE QUANTUM AND CLASSICAL KERNELS

(71) Applicant: International Business Machines Corporation, Armonk, NY (US)

(72) Inventors: Jae-Eun Park, Wappingers Falls, NY (US); Vladimir Rastunkov, Mundelein, IL (US); Shungo Miyabe, Tokyo (JP); Noriaki Shimada, Kawasaki-City (JP); Dimitrios Alevras, WEST CHESTER, PA (US); Brian Leo Quanz, Yorktown Heights, NY (US); ABHIJIT MITRA, THE WOODLANDS, TX (US)

(21) Appl. No.: 18/512,629

(22) Filed: Nov. 17, 2023

(51) Int. Cl. G06N 10/60

(52) U.S. Cl. CPC G06N 10/60

(57) ABSTRACT

A system to train multiple combined quantum classical kernels can comprise a memory that stores, and a processor that executes, computer executable components that perform operations comprising determining a set of kernel bandwidths, calculating a plurality of kernels, based on the kernel bandwidths, for subsets of features of a feature map, centering the plurality of kernels within a feature space of the feature map, regularizing parameters to combine the plurality of kernels, and combining the plurality of kernels into a combined kernel. Feature subsampling and data subsampling can be employed to compute a finite set subsampled kernels. Furthermore, the finite set of subsampled kernels can be combined classically to create a combined kernel that can represent an arbitrary target kernel function of a target dataset.

### BACKGROUND

The subject disclosure relates to quantum kernel learning and, more specifically, to training a combination of multiple quantum and classical kernels.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable training a combination of multiple quantum and classical kernels are discussed.

According to an embodiment, a computer-implemented system is provided. The computer-implemented system can comprise a memory that can store computer executable components. The computer-implemented system can further comprise a processor that can execute the computer executable components stored in the memory, wherein the computer executable components can comprise a computation component that calculates, on logical or physical qubits of a quantum system, a plurality of kernels for subsets of features of a feature map and centers the plurality of kernels within a feature space of the feature map; a regularization component that regularizes parameters to combine the plurality of kernels; and an integration components that combines the plurality of kernels into a combined kernel.

According to another embodiment, a computer-implemented method is provided. The computer-implemented method can comprise calculating, by a system operatively coupled to a processor, a plurality of kernels for subsets of features of a feature map, on logical or physical qubits of a quantum system; centering, by the system, the plurality of kernels within a feature space of the feature map; regularizing, by the system, parameters to combine the plurality of kernels; and combining, by the system, the plurality of kernels into a combined kernel.

According to yet another embodiment, a computer program product for training a combination of multiple quantum and classical kernels is provided. The computer program product can comprise a computer readable storage medium having program instructions embodied therewith, the program instructions executable by a processor to cause the processor to calculate, on logical or physical qubits of a quantum system, a plurality of kernels for subsets of features of a feature map; center the plurality of kernels within a feature space of the feature map; regularize parameters to combine the plurality of kernels; and combine the plurality of kernels into a combined kernel.

### BRIEF DESCRIPTION OF THE DRAWINGS

FIG. 1 illustrates a block diagram of an example, non-limiting system 100 that facilitates training a combination of multiple quantum and classical kernels in accordance with one or more embodiments described herein.

FIG. 2 illustrates a block diagram of an example, non-limiting system that facilitates training a combination of multiple quantum and classical kernels in accordance with one or more embodiments described herein.

FIG. 3A illustrates a block diagram of an example, non-limiting system that facilitates training a combination of multiple quantum and classical kernels in accordance with one or more embodiments described herein.

FIG. 3B illustrates a block diagram of a quantum system that can be employed in connection with the non-limiting systems of FIGS. 1, 2, and 3, in accordance with one or more embodiments described herein.

FIG. 4 illustrates an example, non-limiting representation of a linearly combined set of quantum kernels in accordance with one or more embodiments described herein.

FIG. 5 illustrates example, non-limiting three-dimensional plots of kernels functions over increasing kernel bandwidth for two-dimensional data in accordance with one or more embodiments described herein.

FIG. 6 illustrates example, non-limiting methods to perform regularization on multiple kernel learning models in accordance with one or more embodiments described herein.

FIG. 7 illustrates a block diagram of an example, non-limiting representation of adaptive quantum kernel learning in accordance with one or more embodiments described herein.

FIG. 8 illustrates a flow diagram of an example, non-limiting method 800 of facilitating training a combination of multiple quantum and classical kernels in accordance with one or more embodiments described herein.

FIG. 9 illustrates a flow diagram of an example, non-limiting method 900 of iterative kernel selection in accordance with one or more embodiments described herein.

FIG. 10 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

A kernel is a function that computes a measure of similarity between two data points, typically in a high dimensional space. A quantum kernel is a kernel computed using a quantum computing device and quantum circuits. Quantum machine learning (QML) can employ quantum kernel methods (e.g., quantum support vector machines (QSVM)) to integrate into QML algorithms to perform tasks with higher efficiency or accuracy on real data. It can also be employed for tasks difficult for classical computers (e.g., quantum chemistry simulations, quantum-enhanced optimization, supervised binary classification, regression models). Single quantum kernels have demonstrated matching or exceeding performance of classical kernel methods on real data.

However, existing techniques for performing quantum kernel-based machine learning can be unreliable for various reasons.

First, selection of a kernel for a particular dataset can affect the reliability and accuracy of results, however, methods to determine which kernel function is suitable for the particular dataset comprise iterative processes that are inefficient, costly, resource intensive, and may not be capable of finding a suitable kernel function. Selection of an unsuitable kernel can cause erroneous measuring of similarity between datapoints in a dataset because the kernel function does not accurately describe that dataset and can cause difficulty with classical computation. Parameterized approaches such as quantum kernel alignment (QKA), wherein parameters that define the kernel function can be adjusted based on a dataset to learn an arbitrary target kernel function, comprise frequently revaluating the kernel on quantum hardware after parameter adjustments. More specifically, QKA comprises adjusting parameters that define the kernel function and measuring the impact of such adjustments on the objective kernel function to be optimized. Moreover, revaluation is performed for each parameter in the parametrized quantum kernel being learned. Thus, such iterative processes of QKA can become costly as kernel circuit size scales with number of qubits and features. Additionally, optimization of parameters can frequently get stuck in local optima, saddle points (e.g., points that are neither a local maxima or a local minima), or barren plateaus (e.g., gradient vanishes exponentially in number of qubits), thus becoming computationally intensive and unable to obtain a global minimum.

Second, QKA can result in overfitting of the model, wherein the model accurately makes predictions of training data but is unable to generalize to test data. For example, a model can experience zero error on training data but then perform inaccurately on test data due to overfitting of the model to noise or spurious patters occurring in the training data, and therefore over tailoring to intricacies of the training data. Thus, the model might not generalize underlying data generating processes and cause poor performance on test data.

Third, efficiency and applicability of quantum learning methods can decline as data size, quantum kernel circuit size or quantum hardware size is scaled. In quantum kernel computation, measuring the probability of obtaining a zero state at the end of a quantum circuit becomes challenging as circuit size increases. More qubits used creates more possible states that exist, thus causing obtaining zero state probability to be difficult, if hardware noise and imperfections are present. Furthermore, as the number of qubits increases, exponential concentration of kernels becomes more probable. More specifically, exponential concentration causes obstacles in distinguishing between data points because the probability distribution of measurement outcomes of a quantum system concentrates around a particular value as size of the quantum system increases. Additionally, such methods can be impractical for real-world datasets that comprise large quantities of features because number of qubits scales linearly with number of features. Thus, quantum hardware might not be able to accommodate qubit quantities required for such datasets, and thus limits computation of feature maps. Moreover, sample size poses scalability limitations in quantum kernel learning. For example, if n denotes number of data points of a dataset, computations needed to run on quantum hardware increase quadratically as n increases, consuming time and quantum resources. If quantum kernel-based machine learning, such as QSVM, QKA, or multiple quantum kernel learning, is employed, then n² quantum circuits for each kernel function need to be computed, becoming intractable and limiting to application.

Various embodiments of the present disclosure can be implemented to produce a solution to these problems. Embodiments described herein include systems, computer-implemented methods, and computer program products that can facilitate efficient training a combination of multiple quantum and classic kernels.

In various embodiments, an assignment component can determine a set of kernel bandwidths. In various embodiments, a computation component can calculate, based on the set of kernel bandwidths, a plurality of kernels for subsets of features of a data set and center the plurality of kernels within a feature space of the feature map. More specifically, the feature map can be applied to the subset of features of the dataset. The computation component can further compute a plurality of kernels for subsets of datapoints of a dataset. In various embodiments, a data processing component can perform subsampling of features or datapoints for kernel computation. In various aspects, a regularization component can regularize parameters to combine the plurality of kernels (e.g., regularize weights of the plurality of kernels in linear combination). The regularization component can perform various methods of regularization (e.g., bootstrap resampling, noise-based methods, Frobenius Norm method, iterative selection methods) to the plurality of kernels to mitigate overfitting of a multiple kernel learning model (i.e., a model that learns how to combine multiple kernels into a more effective kernel). Furthermore, in various embodiments, an integration component can classically combine the plurality of kernels to create a combined kernel to model an arbitrary target dataset. In various aspects, the integration component can utilize a non-linear or linear combination of the plurality of kernels to compute the combined kernel. The integration component can create such a kernel without exceeding quantum resource limitations (e.g., number of qubits), mitigating overfitting of the combined kernel, and avoiding optimizing over quantum circuits as each individual quantum kernel in the plurality of kernels is only computed once for a given training dataset, therefore avoiding challenges of quantum optimization. Thus, the methods employed herein may reduce system usage, shots, or quantum processing while maintaining or improving the accuracy of the quantum kernel learning model.

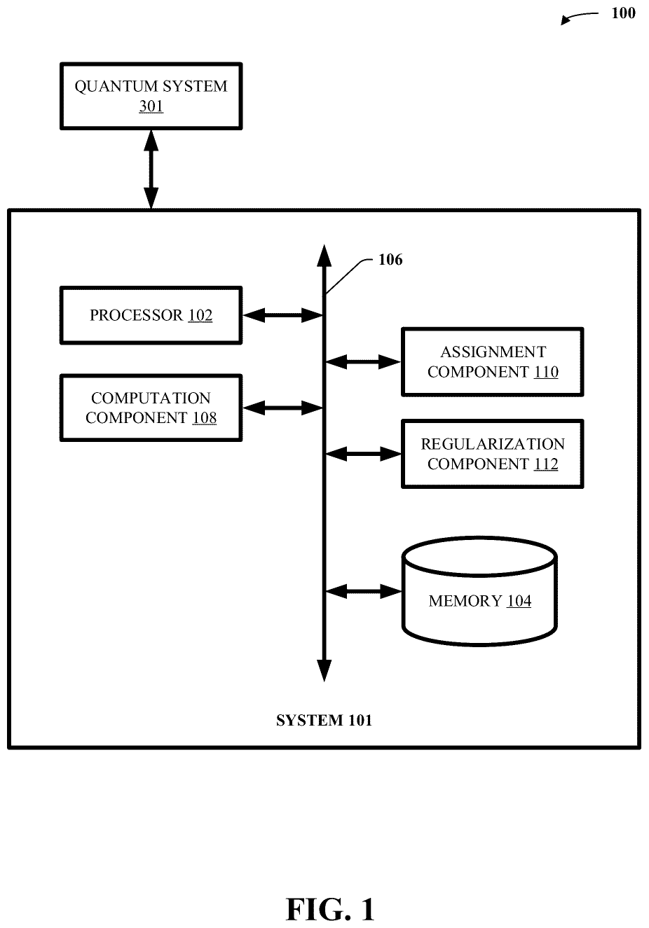

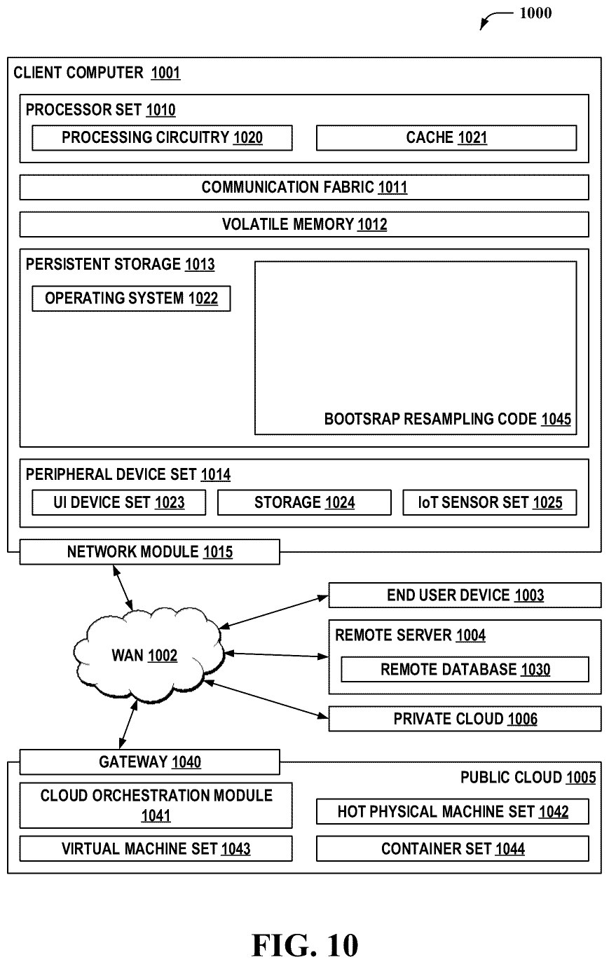

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1000 illustrated at FIG. 10. For example, system 100 can be associated with, such as accessible via, a computing environment 1000 described below with reference to FIG. 10, such that aspects of processing can be distributed between system 100 and the computing environment 1000. In one or more described embodiments, computer and/or computing-based elements can be used in connection with implementing one or more of the systems, devices, components and/or computer-implemented operations shown and/or described in connection with FIG. 1 and/or with other figures described herein.

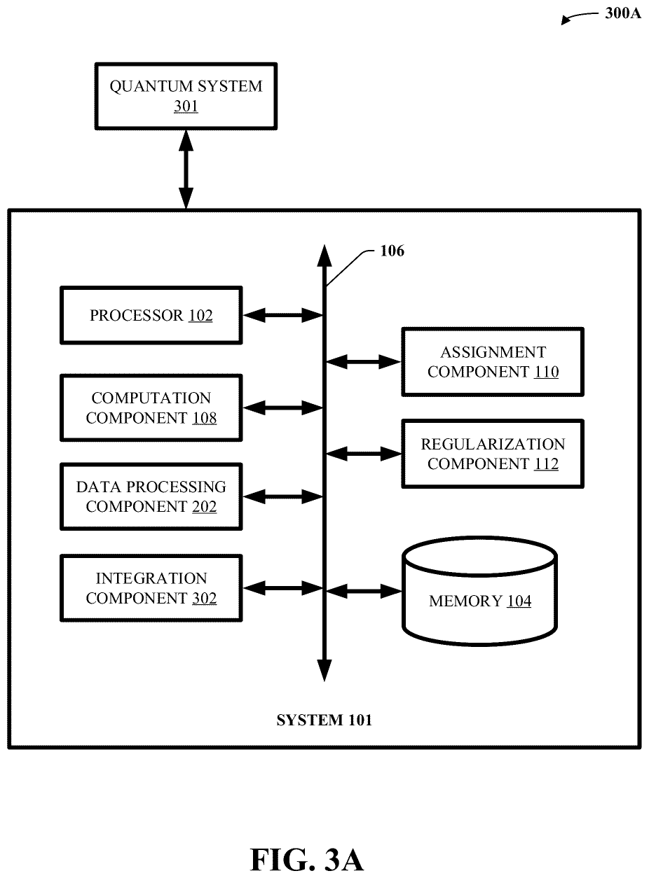

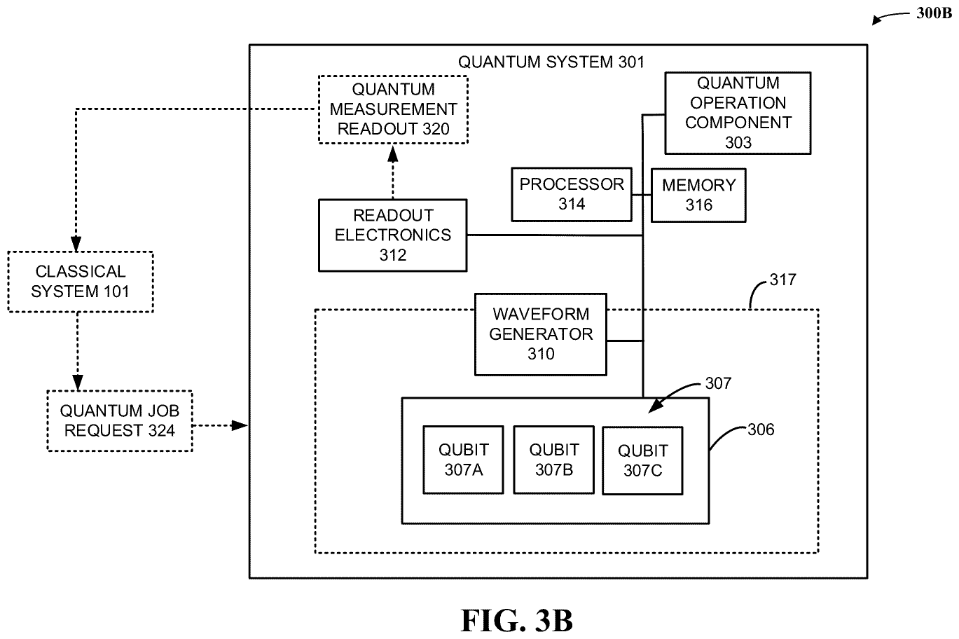

FIG. 1 illustrates a block diagram of an example, non-limiting system 100 that facilitates training a combination of multiple quantum and classical kernels in accordance with one or more embodiments described herein. That is, the non-limiting system 100 can facilitate the process to train a combination of multiple quantum and classical kernels, in combination with employment of a quantum system 301 (FIG. 3B). The non-limiting system 100 can comprise a system 101 and a quantum system 301, to be described in detail below. System 101 can comprise processor 102, memory 104, system bus 106, computation component 108, assignment component 110, and regularization component 112.

The system 100 and/or the components of the system 100 can be employed to use hardware and/or software to solve problems that are highly technical in nature (e.g., related to multiple kernel learning, classification, structured data learning, etc.), that are not abstract and that cannot be performed as a set of mental acts by a human. Further, some of the processes performed may be performed by specialized computers for carrying out defined tasks related to quantum machine learning. The system 100 and/or components of the system can be employed to solve new problems that arise through advancements in technologies mentioned above, computer architecture, and/or the like. The system 100 can provide technical improvements to quantum kernel learning, reducing overfitting of kernel models, optimization efficiency of kernel models, and/or hardware efficiency of quantum kernel learning etc.

Discussion turns briefly to processor 102, memory 104 and bus 106 of system 100. For example, in one or more embodiments, the system 100 can comprise processor 102 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 102 to enable performance of one or more processes defined by such component(s) and/or instruction(s).

In one or more embodiments, system 100 can comprise a computer-readable memory (e.g., memory 104) that can be operably connected to the processor 102. Memory 104 can store computer-executable instructions that, upon execution by processor 102, can cause processor 102 and/or one or more other components of system 100 (e.g., computation component 108, assignment component 110, and/or regularization component 112) to perform one or more actions. In one or more embodiments, memory 104 can store computer-executable components (e.g., computation component 108, assignment component 110, and regularization component 112).

System 100 and/or a component thereof as described herein, can be communicatively, electrically, operatively, optically and/or otherwise coupled to one another via bus 106. Bus 106 can comprise one or more of a memory bus, memory controller, peripheral bus, external bus, local bus, and/or another type of bus that can employ one or more bus architectures. One or more of these examples of bus 106 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

In addition to the processor 102 and/or memory 104 described above, system 100 can comprise one or more computer and/or machine readable, writable and/or executable components and/or instructions that, when executed by processor 102, can enable performance of one or more operations defined by such component(s) and/or instruction(s).

In an embodiment, as described herein, the assignment component 110 can determine a set of kernel bandwidths. More specifically, the assignment component 110 can generate different values of kernel bandwidths that can enable creation of an appropriate combined kernel.

In an embodiment, as described herein, the computation component 108 can calculate, on logical or physical qubits of the quantum system 301, a plurality of kernels (e.g., base kernels), based on the set of kernel bandwidths, for subsets of features of a dataset and center the plurality of kernels within a feature space of the feature map. As an example, a feature map on n-qubits can be defined by Equation 1.

$${𝒰}_{Φ} ( \vec{x} ) = {U}_{Φ ( \vec{x} )} {H}^{⊗ n} , \qquad Equation 1$$

where, U_{Φ(\vec{x})}=exp(iΣ_{S⊆[n]}ϕ_{S}(\vec{x})Π_{i∈S}Pᵢ), [symbol] _{Φ}(\vec{x}) denotes the quantum operators of the feature map, U_{Φ(\vec{x})} denotes a specific unitary operator, H denotes a Hadamard gate, Pᵢ is a Pauli operator corresponding to the i-th qubit, Pᵢ∈{I, X, Y, Z}, and x is a particular data point of a dataset. Moreover, Sis a set of qubit indices that describe connections in the feature map and ϕ_{S}(\vec{x}) is a data-mapping function.

Furthermore, each input data \vec{x}ᵢ can be encoded into an n-qubit quantum state ρ(\vec{x}ᵢ) to give ρ(\vec{x}ᵢ)= [symbol] _{Φ}(\vec{x}ᵢ)ρ₀ [symbol] _{Φ}^{†}(\vec{x}ᵢ), where ρ₀ is some initial state. As described herein, feature subsampling can be executed on the dataset to create subsets of features before applying the feature map. Thus, kernels can be computed for each subset of features.

Moreover, the plurality of kernels can be computed with the determined set of kernel bandwidths. In other words, the assignment component 110 can determine a value of bandwidth for each of the plurality of kernels to be computed with. Thus, when combined, the plurality of kernels can be capable of adapting to an arbitrary target kernel.

In an embodiment, the regularization component 112 can regularize parameters to combine the plurality of kernels. Various regularization methods can be performed on the combination of base kernels to mitigate overfitting of a kernel learning model by creating a combined kernel that is suited to a given dataset and generalize effectively to different samples of the dataset. The regularization component 112 can, for example, utilize iterative selection, bootstrap resampling, noise-based methods, or Frobenius norm methods to achieve avoidance of overfitting. For example, the assignment component 110 can assign weights to the plurality of kernels if linear combination. In an embodiment, the regularization component 112 can regularize the weights assigned to the plurality of kernels. Thus, the plurality of kernels computed from the subsets of features can be classically combined, with weight assignments for each kernel, into a combined kernel to accurately represent similarity of datapoints of a dataset.

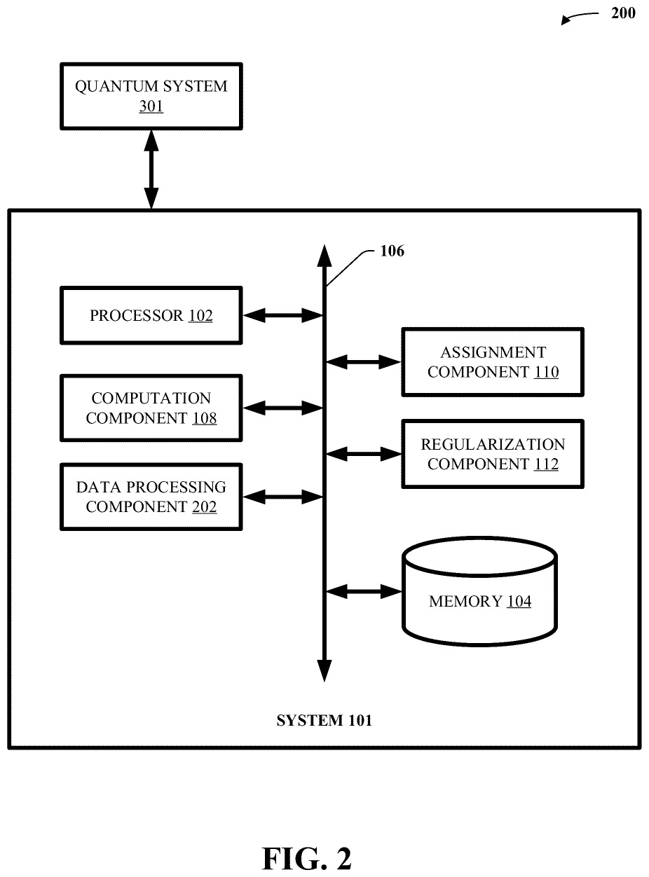

FIG. 2 illustrates a block diagram of an example, non-limiting system 200 that facilitates training a combination of multiple quantum and classical kernels in accordance with one or more embodiments described herein. As shown, system 200 can comprise the same components as system 100, and can further comprise data processing component 202.

In various embodiments, the data processing component 202 can perform feature subsampling on a feature set to generate kernels for subsets of the feature subsamples. In other words, different base kernels can be computed for different subsets of features to enable use of fewer qubits on quantum hardware for kernel computation, as common feature maps utilize one qubit per feature. Subsampling of features can permit scaling of quantum kernel learning for large sizes of feature sets. More specifically, feature dimension can be disregarded after obtaining a kernel function because base kernels comprise the same dimension. For example, if there are N datapoints and P features in a quantum state space, N datapoints can be converted to N training datapoints of an N×N matrix. Feature dimension becomes irrelevant after obtaining similarity between each pair of datapoints because it is implicitly encoded. In other words, although different base kernels comprise different quantities or sets of features, the base kernels will comprise the same dimension for kernel combination.

In various embodiments, the data processing component 202 can use random subsampling of features or systematic subsampling of features. Random subsampling of features can enable use of subsets of features in place of an entire feature set for computing each kernel. For example, fewer qubits are required to run on quantum hardware if computing a quantum kernel matrix with a subset of features due to random subsampling, Therefore, exceeding limitations of number of qubits on the quantum hardware can be mitigated. Furthermore, utilization of fewer qubits can also mitigate error and improve measurement accuracy.

Systematic subsampling of features can comprise determining feature importance based on classical feature selection and computing weighted averages based on classical feature importance. Classical feature selection can comprise selecting, removing, or adding features to target a subset of features, and can additionally be optimized (e.g., backward feature elimination, recursive feature elimination, stepwise feature selection, filter methods, decision trees). Systematic subsampling of features can enable creating distinct spanning subsets, such that features of a subset are not repeating or all features are represented. In other words, systematic subsampling can create subsets that represent a variety of feature combinations. As another example of how data processing component 202 can execute systematic subsampling, features can be weighted by the assignment component 110 based on classical feature selection or feature importance to determine how features are subsampled. More specifically, if a feature is useful in a classical model of a dataset, then there exists a higher probability that the feature is useful for a quantum model of the dataset. Thus, the assignment component 110 can assign a higher weight to that feature during subsampling of features for kernel computation. Weight assignment of features or feature subsets can create a bias in sampling for computation of quantum kernels that represents a feature space effectively. The bias can emphasize particular subsets of features that have high probabilities of success while maintaining randomness to achieve discovery of feature combinations that will be more effective in quantum models than in classical models. Moreover, use of feature subsets to compute a set of base kernels can mitigate exponential concentration caused by use of large numbers of qubits because subsampled individual kernels can be computed and combined classically, avoiding a large quantum space.

In various embodiments, the computation component 108 can engage the data processing component 202 to subsample datapoints of a dataset and define a plurality of subsampled kernels for the subsampled datapoints. Similar to feature subsampling, different kernels can be computed for different subsets of datapoints to mitigate limitations from sample size of a dataset. More specifically, a kernel can be computed on a subset of a dataset instead of the entire dataset for a particular feature mapping kernel function. For example, if N datapoints exist, a subsample of datapoints of size K such that K<N can be used to compute a kernel. Therefore, only K² circuits are run on the quantum hardware instead of N² circuits, conserving quantum resources. Furthermore, various techniques can be used to fill missing datapoints of the N×N kernel matrix based on the subsample of datapoints of size K. For example, the computation component 108 can use a collaborative filtering method or a trained predictive model to predict missing values in the kernel matrix given a pair of inputs, and thus obtain an approximated kernel of a quantum kernel. In various embodiments, the data processing component 202 can employ datapoint subsampling to create approximated kernels of the plurality of kernels, enhancing efficiency by utilizing a subset of a dataset in place of the entire dataset, from which the integration component 302 can combine the approximated kernels into a combined kernel. Therefore, datapoint subsampling can enable scaling to datasets containing larger quantities of datapoints with minimized usage of quantum resources.

FIG. 3A illustrates a block diagram of an example, non-limiting system 300A that facilitates training a combination of multiple quantum and classical kernels in accordance with one or more embodiments described herein. As shown, system 300A can comprise the same components as system 200, and can further comprise integration component 302.

In various embodiments, the integration component 302 can combine a plurality of subsampled kernels with a respective kernel of the plurality of kernels. Subsampled kernels (e.g., base kernels) can comprise classical or quantum kernels. In other words, the integration component 302 can combine kernels into a single combined kernel no matter the type of base kernel. Thus, quantum modelling can be combined with classical modeling features after computation of kernel matrices or kernel functions. Furthermore, each base kernel can comprise different feature maps or bandwidths to enable creation of a flexible combined kernel that can represent an arbitrary target kernel function of a dataset.

In various aspects, the integration component 302 can employ linear or non-linear models to combine the plurality of kernels. For example, the integration component 302 can utilize a non-linear polynomial combination of the plurality of kernels to compute the combined kernel. As another example, the integration component 302 can utilize a neural network to transform and combine the plurality of kernels. As yet another example, and described herein, the integration component 302 can linearly combine the plurality of kernels based on weights assigned, by the assignment component 110, to the plurality of kernels.

In various embodiments, the data processing component 202 can implicitly learn which features to select such that important features are weighted heavier than irrelevant features by the assignment component 110 for kernel combination. Thus, the integration component 302 can implicitly learn to create a complex kernel function from the base kernels to include all features of the feature space without exceeding computation or resource limitations. Therefore, minimum quantum resources can be used in quantum machine learning applied on practical real datasets.

Turning to FIG. 3B, one or more embodiments described herein can include one or more devices, systems and/or apparatuses that can provide a process to train a combination of multiple quantum and classical kernels. Accordingly, at FIG. 3B, illustrated is a block diagram of an example, non-limiting system 300B that can at least partially facilitate such a process. While referring here to one or more processes, facilitations and/or uses of the non-limiting system 300B, description provided herein, both above and below, also can be relevant to one or more other non-limiting systems described herein, such as the non-limiting systems 100, 200 and/or 300A.

As illustrated at FIG. 300B, the non-limiting system 300B can comprise a quantum system 301 that can be employed with or separate from the classical system 101.

Generally, the quantum system 301 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits, physical circuit level components, high level components and/or functions. The quantum circuitry can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement readout 320, can be responsive to the quantum job request 324 and associated input data and can be based at least in part on the input data, quantum functions and/or quantum computations.

In one or more embodiments, the quantum system 301 can comprise components, such as a quantum operation component 303, a quantum processor 306, pulse component 410 (e.g., a waveform generator) and/or a readout electronics 312 (e.g., readout component). In one or more other embodiments, the readout electronics 312 can be comprised at least partially by the classical system 101 and/or be external to the quantum system 301. The quantum processor 306 can comprise one or more, such as plural, qubits 307. Individual qubits 307A, 307B and 307C, for example, can be fixed frequency and/or single junction qubits, such as transmon qubits.

In one or more embodiments, a memory 316 and/or processor 314 can be associated with the quantum operation component 303, where suitable. The processor 314 can be any suitable processor. The processor 314 can generate one or more instructions for controlling the one or more processes of the quantum operation component 303.

The quantum operation component 303 can obtain (e.g., download, receive, search for and/or the like) a quantum job request 324 requesting execution of one or more quantum programs and/or a physical qubit layout. The quantum job request 324 can be provided in any suitable format, such as a text format, binary format and/or another suitable format. In one or more embodiments, the quantum job request 324 can be obtained by a component other than of the quantum system 301, such as a by a component of the classical system 101.

The quantum operation component 303 can determine mapping of one or more quantum logic circuits for executing a quantum program. In one or more embodiments, the quantum operation component 303 and/or quantum processor 306 can direct the waveform generator 310 to generate one or more pulses, tones, waveforms and/or the like to affect one or more qubits 307, such as in response to a quantum job request 324.

The waveform generator 310 can generally cause the quantum processor 306 to perform one or more quantum processes, calculations and/or measurements by creating a suitable electro-magnetic signal. For example, the waveform generator 310 can operate one or more qubit effectors, such as qubit oscillators, harmonic oscillators, pulse generators and/or the like to cause one or more pulses to stimulate and/or manipulate the state(s) of the one or more qubits 307 comprised by the quantum system 301.

The quantum processor 306 and a portion or all of the waveform generator 310 can be contained in a cryogenic environment, such as generated by a cryogenic environment 317, such as effected by a dilution refrigerator. Indeed, a signal can be generated by the waveform generator 310 to affect one or more of the plurality of qubits 307. Where the plurality of qubits 307 are superconducting qubits, cryogenic temperatures, such as about 4K or lower, can be employed for function of these physical qubits. Accordingly, one or more elements of the readout electronics 312 also can be constructed to perform at such cryogenic temperatures.

The readout electronics 312, or at least a portion thereof, can be contained in the cryogenic environment 317, such as for reading a state, frequency and/or other characteristic of qubit, excited, decaying or otherwise.

It is noted that the aforementioned description(s) refer(s) to the operation of a single set of instructions run on a single qubit. However, scaling can be achieved. For example, instructions can be calculated, transmitted, employed and/or otherwise used relative to one or more qubits (e.g., non-neighbor qubits) in parallel with one another, one or more quantum circuits in parallel with one another, and/or one or more qubit mappings in parallel with one another.

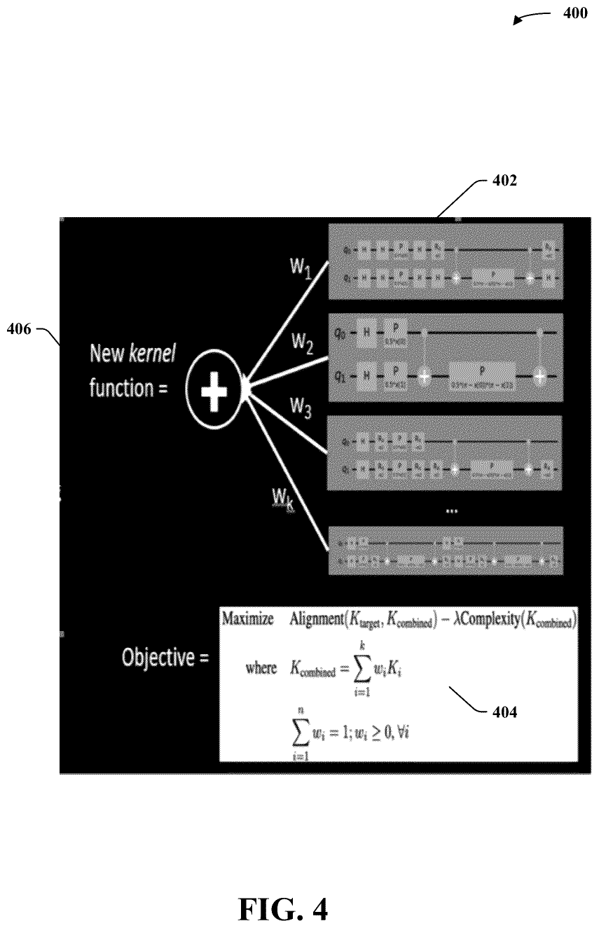

FIG. 4 illustrates an example, non-limiting representation of a linearly combined set of quantum kernels in accordance with one or more embodiments described herein.

In various embodiments, a finite set of kernels can be defined by quantum circuits 402, wherein the finite set of kernels can comprise k kernels, such that a particular kernel is denoted by Kᵢ. A combined kernel, denoted by K_{combined}, can be defined by equation 404, that states K_{combined}=Σᵢ₌₁^{k}wᵢkᵢ, where Σᵢ₌₁ⁿwᵢ=1 such that wᵢ≥0, ∀i. Furthermore, wᵢ denotes weight of kernel Kᵢ, determined by assignment component 110. Weight wᵢ can, in some cases, emphasize importance of kernel Kᵢ, or else specify a coefficient needed to create an arbitrary kernel that best aligns with the target kernel (e.g., if a sufficient number of base kernels are used and the base kernels are selected appropriately, by methods described later, then a linear combination of the base kernels can create an arbitrary kernel). The finite set of kernels can be combined classically by the integration component 302. For example, equation 404 classically combines kernels as a linear combination of kernels. Thus, the combined kernel can be computed by a single computation of each kernel Kᵢ in the finite set of kernels. Classical combination of a finite set of kernels can prevent repetitive parameter tuning and testing of a quantum kernel, mitigating use of additional time and quantum resources. Moreover, classical combination of a finite set of kernels can prevent Barren plateaus and being caught at a local minima because quantum optimization is not applied, and the final classical optimization problem can be efficiently solved to optimality.

In various embodiments, the assignment component 110 can execute kernel-target alignment to determine weights wᵢ in equation 404. Kernel-alignment is a measure of similarity between a kernel and a target kernel function. The quantity for a kernel K₁ and a kernel K₂ can be denoted by Equation 2.

$$\hat{A} ( {K}_{1} , {K}_{2} ) = \frac{{〈 {K}_{1} , {K}_{2} 〉}_{F}}{\sqrt{{〈 {K}_{1} , {K}_{1} 〉}_{F} {〈 {K}_{2} , {K}_{2} 〉}_{F}}} , \qquad Equation 2$$

where [symbol] K₁, K₂ [symbol] _{F}=Σ_{i,j=1}^{m}K₁(xᵢ, xⱼ)K₂(xᵢ, xⱼ) is an inner product between kernel matrices given a sample dataset S={x₁, . . . , xₘ}.

Â(K, K_{y}) is maximized with respect to wᵢ to achieve optimal alignment between kernel K and target kernel K_{y}, defined by Equation 3.

$${max}_{{w}_{i}} A ( K , {K}_{y} ) \qquad Equation 3$$

such that Tr(K)=1, where, for classification machine learning tasks, i, j elements of the target kernel K_{y} can be defined as

$${( {K}_{y} )}_{ij} = \{ \begin{matrix}1 , & if {y}_{i} = {y}_{j} \\ 0 , & otherwise .\end{matrix}$$

Similar definitions of the i, j elements of the target kernel K_{y} can be made for other types of machine learning tasks.

In various aspects, kernel-target alignment can optimize assignment of weights of the finite set of kernels and kernel alignment to a target kernel to enable computation of a flexible combined kernel that can represent an arbitrary target kernel function.

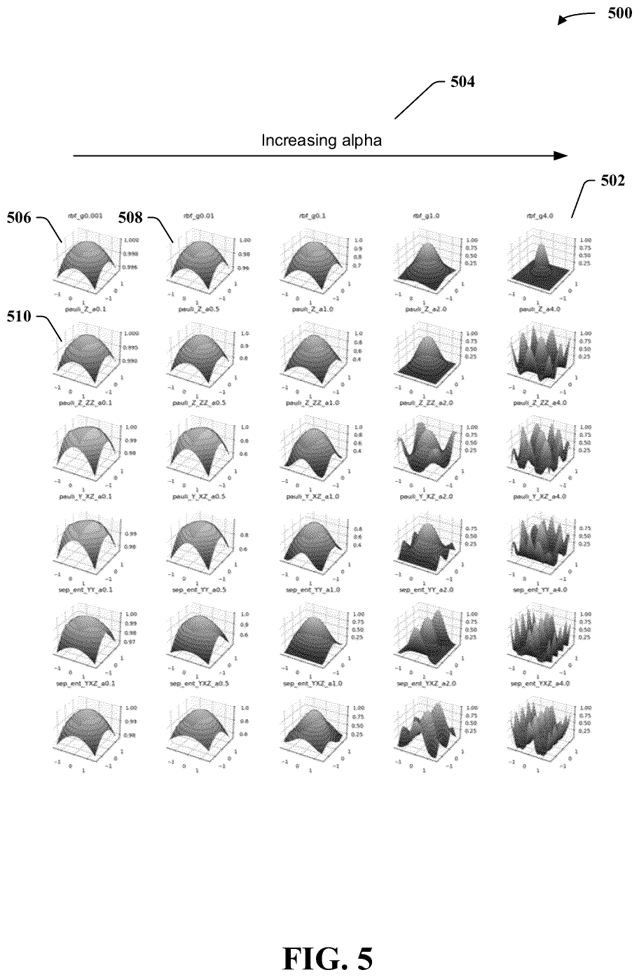

FIG. 5 illustrates example, non-limiting three-dimensional plots of kernels functions over increasing kernel bandwidth for two-dimensional data in accordance with one or more embodiments described herein.

In various aspects, alpha (e.g., kernel bandwidth) can be a parameter of a kernel function. Bandwidth of a kernel scales width of a kernel function to control smoothing of the kernel function. In the case of quantum kernels, kernel bandwidth can also control the frequency of the kernel function, as quantum kernels can effectively encode sinusoidal functions (i.e., as one data point moves farther from another data point in a particular direction in a feature space defined by a kernel function, in the case of quantum kernels, the kernel function can exhibit periodic or oscillatory output for which the frequency increases with increasing kernel bandwidth). Chart 500 depicts a set of kernel functions 502, such that each row illustrates a distinct kernel function and Pauli feature map (e.g., a classical kernel function in the first row, a quantum kernel function in each row below the first row) over increasing alphas across columns. For each three-dimensional plot of a kernel function, one data point is fixed at the origin, and x and y values of a second data point are varied, with a corresponding kernel value plotted on the z-axis (e.g., the surface). As shown by 504, alpha increases from left to right over the set of kernel functions 502. For example, kernel function 506 and kernel function 508 are the same kernel function, except utilize different values of alpha (e.g., α=0.1 for kernel function 506 and α=0.5 for kernel function 508). Chart 500 also depicts a distinct kernel function for each row of kernel functions 502. For example, kernel function 506 is a different kernel function than kernel function 510, however, both use a same value of alpha (e.g., α=0.1). As depicted in chart 500, if alpha is held at a fixed value for a set of different kernel functions, the set of different kernel functions exhibit limited variation. Furthermore, if alpha is held fixed within a limited range for a particular kernel function, the kernel function also exhibits limited variation, as shown in chart 500. In other words, kernel functions do not vary unless bandwidth is varied among kernel functions. Therefore, a combined kernel of a set of base kernels that share a similar range or value of alpha can exhibit limited variability from the base kernels, causing difficulty in ability to represent an arbitrary target kernel function for a dataset. The combined kernel might lack flexibility to accurately model the dataset due to a lack of variability within the base kernels.

In various embodiments, the integration component 302 can allow for base kernels comprising different parameters (e.g., bandwidth) to enable creation of a flexible combined kernel that can capture an arbitrary target kernel function for a dataset. In various aspects, the assignment component 110 can compute a sequence of alpha values, such that frequency of values of kernel functions for data in a normalized data region (e.g., −1 to 1) is inclusive (e.g., includes full or representative set of frequencies based on single dimension calculations), and can be determined based on cyclical periods computed in the normalized data region. Thus, a sequence of increasing alpha values corresponding to each period can be computed for a given quantum feature map. For each alpha value in the sequence of alpha values, the computation component 108 can compute a kernel corresponding to each frequency. Thus, the integration component 302 can combine the computed kernels for each alpha value to create a combined kernel representative for an arbitrary target dataset. Such an approach can ensure that arbitrary target kernel functions can be approximated by combining kernel functions corresponding to different frequencies and can further ensure a diverse set of base kernel functions are used to create an arbitrary combination of base kernel functions. Ability to incorporate base kernels of different alphas can also avoid exponential concentration of kernels, even if base kernels are the same or utilize the same number of qubits. In other words, such an approach can mitigate limited variation caused by utilization of a fixed value range of alpha by using a sequence of alpha values to ensure diverse base kernel functions for flexibility of a combined kernel function to fit an arbitrary target dataset.

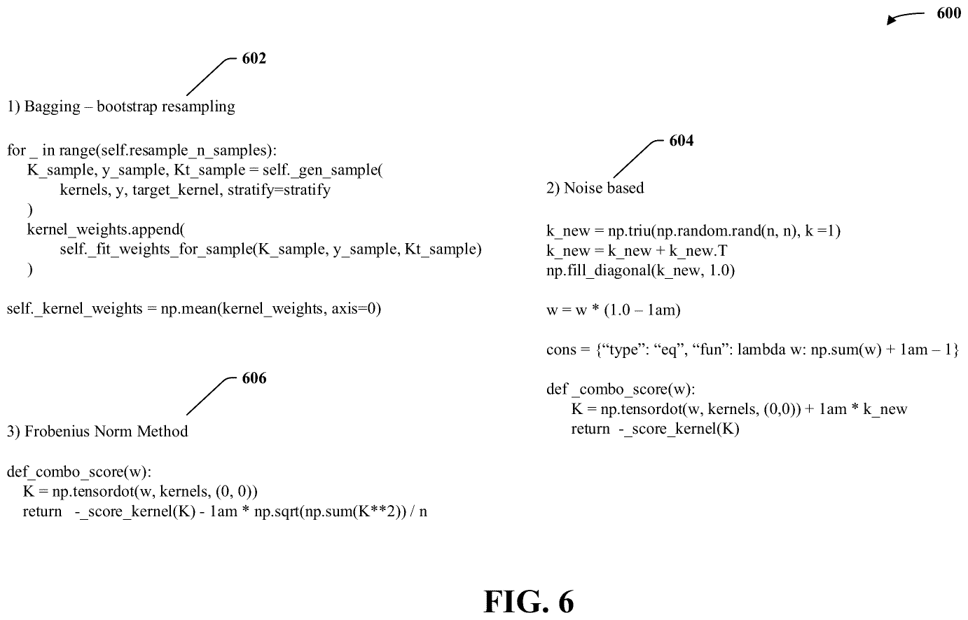

FIG. 6 illustrates example, non-limiting methods to perform regularization on multiple learning kernel models in accordance with one or more embodiments described herein.

In various instances, the regularization component 112 can perform bootstrap resampling (e.g., bagging), as shown in algorithm 602, on kernel matrices as a regularization method to mitigate overfitting of a model. Bootstrap resampling can comprise resampling kernels (e.g., treat kernels as originating from resampled data) and optimizing a weighted combination of the resampled kernels. One or more additional kernels can be added to the finite set of kernels to avoid overfitting by introducing noise. Furthermore, bootstrap resampling can enhance efficiency of classical optimization and combining of the finite set of kernels without significant performance penalty.

In various aspects, the regularization component 112 can utilize a noise-based method 604 to prevent overfitting of a model. The noise-based method 604 can include one or more additional noisy kernels into the finite set of kernels that are assigned weights by the assignment component 110. Thus, the noise-based method 604 can mitigate overfitting of a model on training data by including and weighting noise from additional kernels. That is, by including additional noise to the model, the existing kernels of the finite set of kernels can be prevented from overfitting a target dataset when the kernels are combined by the integration component 302.

In various embodiments, the regularization component 112 can regularize a combined kernel by including, as shown in algorithm 606, a Frobenius Norm of kernels matrices. The Frobenius norm of a matrix is the square root of the sum of the squares of elements of the matrix. In algorithm 606, K denotes the sum of the product of the weights of the base kernels to create the combined kernel. Inclusion of the Frobenius Norm of kernel matrices can prevent the kernel matrices from overfitting a training dataset.

In various embodiments, the regularization component 112 can also utilize an iterative selection approach to refine selection of kernels to be included in the combined kernel. The iterative selection approach can comprise engaging the computation component 108 to compute alignment between kernels in a finite set of kernels and iteratively selecting a kernel that is most aligned with a target kernel. Iterative selection can further comprise removing kernels that are most aligned with the selected kernel. Such a method can avoid overfitting of a model because redundant or aligned kernels that can skew kernel combination are removed. Other methods to create a sparser set of diverse, non-aligned kernels can also be employed.

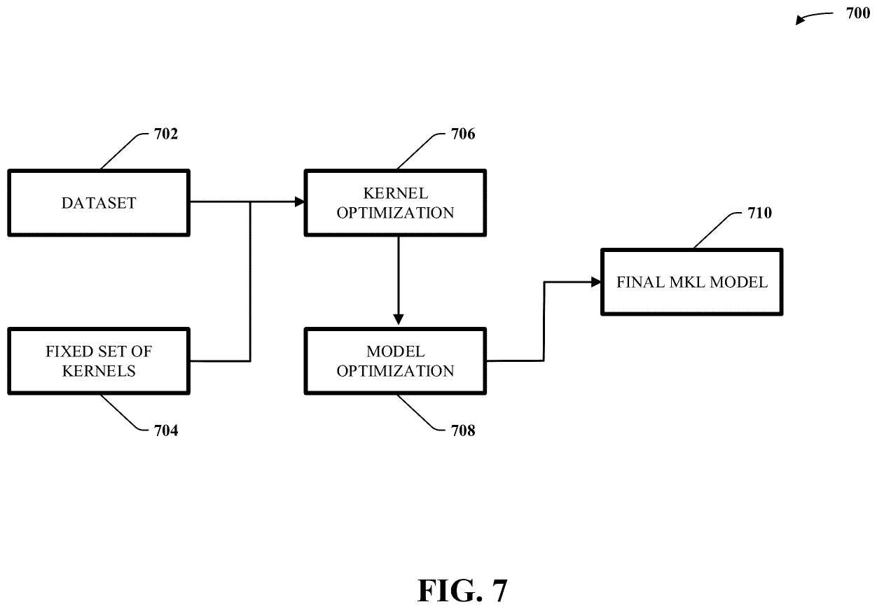

FIG. 7 illustrates a block diagram of an example, non-limiting representation of adaptive quantum machine kernel learning in accordance with one or more embodiments described herein.

In various embodiments, there can be a dataset 702. In various aspects, the data processing component 202 can perform feature subsampling or data subsampling on a dataset 702. In various embodiments, there can be a fixed set of kernels 704 that comprise quantum kernels or classical kernels. Furthermore, quantum kernels of the fixed set of kernels 704 can be defined, for example, by Pauli matrices and undergo any suitable number of repetitions of execution of a respective quantum circuit. Quantum kernels of the fixed set of kernels 704 can use a fixed set of values of alpha (e.g., bandwidth) or the computation component 108 can compute a representative set of values of alphas. Moreover, classical kernels of the fixed set of kernels 704 can comprise, for example, radial basis function kernels with varying values of gamma or can comprise any suitable properties (e.g., linear, polynomial). The computation component 108 can engage data processing component 202 to perform kernel optimization 706 on the fixed set of kernels 704 to obtain an optimal combined kernel. In various embodiments, the computation component 108 can engage the assignment component 110 to calculate weights, for linear combinations, for each kernel in the fixed set of kernels 704. Thus, the integration component 302 can utilize the calculated weights of each kernel to compute the combined kernel. The integration component 302 can also utilize non-linear models to compute the combined kernel. Moreover, kernel optimization 706 can employ various other methods (e.g., kernel-target alignment, geometric differences, projection). After kernel optimization 706, the computation component 108 can perform model optimization 708. Model optimization 708 can comprise performing optimization of hyperparameters or regularization (e.g., noise-based methods, bootstrap resampling, iterative selection, Frobenius Norm methods) by the regularization component 112 to mitigate overfitting of the dataset 702.

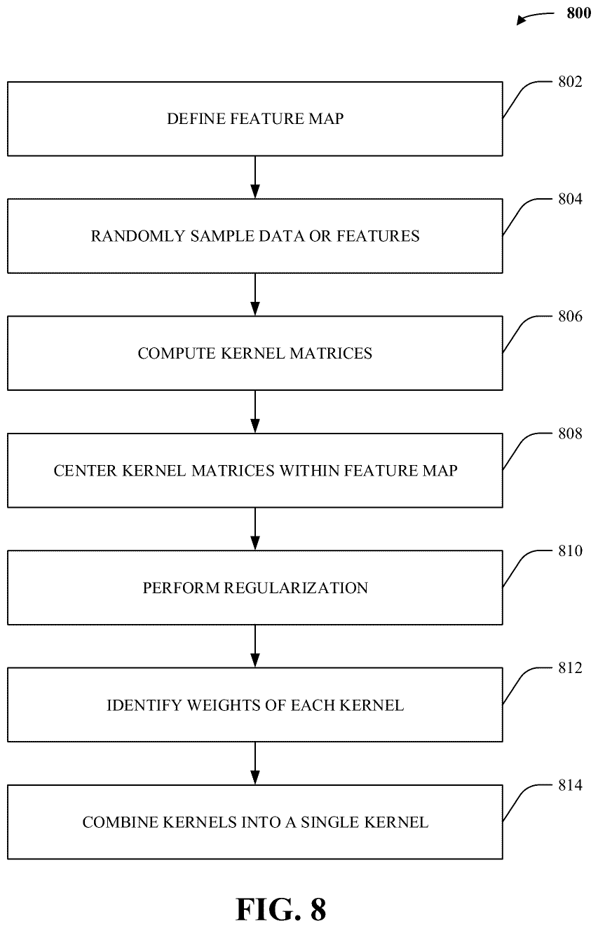

FIG. 8 illustrates a flow diagram of an example, non-limiting method 800 of facilitating training a linear combination of multiple quantum and classical kernels in accordance with one or more embodiments described herein. Repetitive description of like elements and/or processes employed in respective embodiments is omitted for sake of brevity.

At 802, the non-limiting method 800 can comprise defining (e.g., by computation component 108), by the system, a feature map.

At 804, the non-limiting method 800 can comprise randomly sampling (e.g., by data processing component 202), by the system, data of a dataset or features of a feature set.

At 806, the non-limiting method 800 can comprise computing (e.g., by computation component 108), by the system, kernel matrices.

At 808, the non-limiting method 800 can comprise centering (e.g., by computation component 108), by the system, kernel matrices within the feature map.

At 810, the non-limiting method 800 can comprise performing (e.g., by regularization component 112), by the system, regularization on kernel matrices.

At 812, the non-limiting method 800 can comprise identifying (e.g., by assignment component 110), by the system, weights of each kernel.

At 814, the non-limiting method 800 can comprise combining (e.g., by integration component 302), by the system, kernels into a single kernel.

For example, a feature map can be defined as a Pauli feature map defined from a set of Pauli matrix strings {(“Z”), (“XY”), (“XZ”), (“YY”), (“YZ”), (“ZZ”), (“X”, “XZ”), (“X”, “YZ”), (“X”, “ZZ”), (“Y”, “YY”), (“Y”, “YZ”), (“Y”, “ZZ”), (“Z”, “XZ”), (“Z”, “YY”), (“Z”, “YZ”), (“Z”, “ZZ”)} and parameters alpha from (0.25, 0.5, 1) with repetitions from [1,2]. For this example, there exist 96 combinations of kernel matrices defined by particular combinations of parameters of selected Pauli strings, alpha, and repetitions. Then, optional random sampling of kernels can be performed by data processing component 202. Random sampling can be performed when feature map grids or datasets are large and cause full kernel matrix calculation to be expensive or resource intensive. If random sampling is not performed, the computation component 108 can compute 96 kernel matrices for each combination of Pauli matrix and parameters using various kernel computation methods (e.g., SWAP tests, projective kernels, compute-uncompute tests). After computation of kernel matrices, computation component 108 can optionally center the kernel matrices within a feature space of the Pauli feature map. Subsequently, the regularization component 112 can perform regularization on the set of kernels. For example, the regularization component 112 can execute iterative kernel selection to reduce the number of kernels to a sparse diverse set of kernels to mitigate overfitting. After regularization methods are applied, the regularization component 112 can use an optimization procedure (e.g., constrained optimization by linear approximations (COBYLA)) to compute and identify weights for each kernel. More specifically, the regularization component 112 can identify the weights by simultaneously maximizing regularization of the parameters for kernel combination with alignment of the combined kernel to a target kernel to achieve less overfitting. In various aspects, tuning of the weights determined through maximizing regularization and kernel alignment can be performed through, for example, machine learning tuning approaches such as validation (i.e., testing different values and observing which values yield appropriate results on hold-out validation datasets). Thus, the integration component 302 can linearly combine the set of kernels using the computed weights with equation 404 to create a single combined kernel that can represent an arbitrary target kernel function.

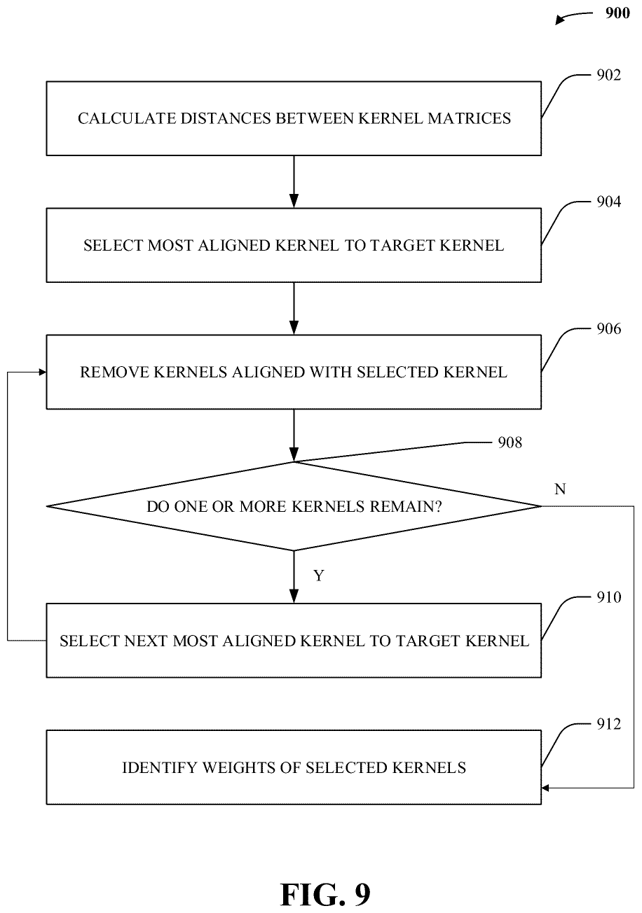

FIG. 9 illustrates a flow diagram of an example, non-limiting method 900 of iterative kernel selection in accordance with one or more embodiments described herein. Repetitive description of like elements and/or processes employed in respective embodiments is omitted for sake of brevity.

At 902, the non-limiting method 900 can comprise calculating (e.g., by computation component 108), by the system, distances between kernel matrices.

At 904, the non-limiting method 900 can comprise selecting (e.g., by regularization component 112), by the system, a most aligned kernel to a target kernel.

At 906, the non-limiting method 900 can comprise removing (e.g., by regularization component 112), by the system, kernels aligned with the selected kernel (e.g., according to a threshold alignment value).

At 908, the non-limiting method 900 can determine if one or more kernels remain. If yes, the non-limiting method 900 can proceed to 910. If no, the non-limiting method 900 can proceed to 912.

At 910, the non-limiting method 900 can comprise selecting (e.g., by regularization component 112), by the system, a next most aligned kernel to the target kernel.

At 912, the non-limiting method 900 can comprise identifying (e.g., by assignment component 110), by the system, weights of the selected kernels.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively train multiple combined quantum classical kernels as the one or more embodiments described herein can enable this process. And, neither can the human mind nor a human with pen and paper train multiple combined quantum classical kernels, as conducted by one or more embodiments described herein.

FIG. 10 illustrates a block diagram of an example, non-limiting, operating environment in which one or more embodiments described herein can be facilitated. FIG. 10 and the following discussion are intended to provide a general description of a suitable operating environment 1000 in which one or more embodiments described herein at FIGS. 1-17 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as bootstrap resampling code 1045. In addition to block 1045, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1045, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1045 in persistent storage 1013.

COMMUNICATION FABRIC 1011 is the signal conduction paths that allow the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface type operating systems that employ a kernel. The code included in block 1045 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a processor that executes computer-executable components stored in a non-transitory computer-readable memory, the computer-executable components comprising:
a computation component that calculates, on logical or physical qubits of a quantum system, a plurality of kernels for subsets of features of a feature map and centers the plurality of kernels within a feature space of the feature map;
a regularization component that regularizes parameters to combine the plurality of kernels; and
an integration component that combines the plurality of kernels into a combined kernel.

2. The system of claim 1, further comprising a data processing component that performs feature subsampling and data subsampling on a dataset to generate kernels for subsets of the feature subsamples or data subsamples.

3. The system of claim 1, wherein a selection of the plurality of features is determined randomly or systematically through classical feature selection.

4. The system of claim 1, wherein the computation component calculates matrices of the plurality of kernels with compute-uncompute tests, SWAP tests, or projected kernel computations.

5. The system of claim 2, wherein the computation component engages the data processing component to subsample datapoints of a dataset and define a plurality of subsampled kernels for the subsampled datapoints in calculation of a kernel of the plurality of kernels.

6. The system of claim 5, wherein the integration component combines the plurality of subsampled kernels arising from the respective kernels of the plurality of kernels.

7. The system of claim 1, further comprising selecting distinct kernels using iterative procedures for kernel alignment with a target kernel to enable hardware efficient kernels and a reduction in kernels used during training and testing.

8. The system of claim 1, wherein the regularization component performs regularization on the parameters to combine the plurality of kernels based on bootstrap resampling, noise, a Frobenius norm method, or the distinct kernels.

9. The system of claim 1, wherein the regularization component regularizes weights assigned to the plurality of kernels, and wherein the integration component linearly combines the plurality of kernels based on the regularized weights.

10. The system of claim 1, further comprising an assignment component that determines a set of kernel bandwidths, and wherein the computation component calculates the plurality of kernels based on the kernel bandwidths.

11. The system of claim 1, wherein the regularization component maximizes regularization of the parameters with alignment of the combined kernel to a target kernel.

12. A computer-implemented method, comprising:
calculating, by the system, on logical or physical qubits of a quantum system, a plurality of kernels for subsets of features of a feature map;
centering, by the system, the plurality of kernels within a feature space of the feature map;
regularizing, by the system, parameters to combine the plurality of kernels; and
combining, by the system, the plurality of kernels into a combined kernel.

13. The computer-implemented method of claim 12, further comprising performing feature subsampling and data subsampling on a dataset to generate kernels for subsets of the feature subsamples or data subsamples.

14. The computer-implemented method of claim 9, further comprising preparing an input dataset with principal component analysis to reduce dimensionality of the input dataset.

15. The computer-implemented method of claim 13, further comprising subsampling datapoints of a dataset and defining a plurality of subsampled kernels for the subsampled datapoints in calculation of a kernel of the plurality of kernels.

16. The computer-implemented method of claim 15, further comprising combining the plurality of subsampled kernels arising from the respective kernels of the plurality of kernels.

17. The computer-implemented method of claim 12, further comprising selecting distinct kernels using iterative procedures for kernel alignment with a target kernel to enable hardware efficient kernels and a reduction in kernels used during training and testing.

18. The computer-implemented method of claim 12, further comprising performing regularization on the parameters to combine the plurality of kernels based on bootstrap resampling, noise, a Frobenius norm method, or the distinct kernels.

19. A computer program product comprising a non-transitory computer-readable memory having program instructions embodied therewith, the program instructions executable by a processor to cause the processor to:
calculate, on logical or physical qubits of a quantum system, a plurality of kernels for subsets of features of a feature map;
center the plurality of kernels within a feature space of the feature map;
regularize parameters to combine the plurality of kernels; and
combine the plurality of kernels into a combined kernel.

20. The computer program product of claim 19, wherein the program instructions are further executable to cause the processor to:
combine a plurality of subsampled kernels arising from the respective kernels of the plurality of kernels.
